(19) United States
(12) Patent Application Publication
(10) Pub. No.: US 2012/0150747 A1
(43) Pub. Date: Jun. 14, 2012

(54) MOBILE COMMUNICATION DEVICES

(75) Inventor: Jason Carey, Windsor (GB)

(73) Assignee: SWIPE PAY LIMITED, Maidenhead, Berkshire (GB)

(21) Appl. No.: 13/320,380

(22) PCT Filed: Aug. 25, 2011
(86) PCT No.: PCT/GB11/51604

§ 371 Date: Feb. 9, 2012

(30) Foreign Application Priority Data
Aug. 31, 2010 (GB) 1014408.7

(51) Int. Cl. G06Q 20/40

(52) U.S. Cl. 705/71

(57) ABSTRACT

A mobile communication device, the device comprising: a memory; an encryption module for encrypting data using an encryption key; a first communication channel configured to transfer the encryption key from the mobile communication device to a separate terminal; and a second communication channel for transferring payment details stored in the memory from the mobile communication device to the separate terminal, which payment details are encrypted using the encryption key; and wherein the first communication channel is different to the second communication channel.

### FIELD OF THE INVENTION

The present invention relates to mobile communication devices, to payment terminals, to payment systems, to related methods and to computer programs for implementing the same.

### BACKGROUND TO THE INVENTION

Payment using a credit or debit card at a Point Of Sale (POS) device using so-called “chip-and-pin” is now commonplace, but there are growing concerns that these payment methods may be vulnerable to third party attack and become compromised.

It is an aim of preferred embodiments of the present invention to provide an improved card-based transaction system and elements thereof.

### SUMMARY OF THE INVENTION

According to the present invention in a first aspect, there is provided a mobile communication device, the device comprising:
a memory;
an encryption module for encrypting data using an encryption key;
a first communication channel configured to transfer the encryption key from the mobile communication device to a separate terminal; and
a second communication channel for transferring payment details stored in the memory from the mobile communication device to the separate terminal, which payment details are encrypted using the encryption key; and
wherein the first communication channel is different to the second communication channel.

Suitably, the mobile communication device further comprises:
a display screen; and
a machine readable image generator, configured to generate an image on the display screen, the image comprising an encrypted version of the encryption key. This can therefore be the first communication channel.

Suitably, the device is configured to transfer using the first communication channel data identifying the device. Suitably, the image further comprises data identifying the device. Suitably, the identifying data is the device's Media Access Control (MAC) address.

Suitably, the device comprises a wireless transmitter configured to transmit encoded payment details encrypted using the encryption key. Suitably, the wireless transmission is via a Bluetooth channel. This wireless transmission can therefore be the second communication channel.

Suitably, the payment details are selected from any combination of any of: card type, payment method, valid from, account number, issue number, expiry date, cardholder name, card number and secure code.

Suitably, the device is configured whereby upon receipt of a verification code request from a payment terminal, a user is requested to input a verification code, which verification code is transmitted to the payment terminal. The verification code request may not be an explicit request, but may be implicit from another data transmission that triggers the request for the verification code. Suitably, a one-way operation, such as a hash or add salt and hash operation is carried out on the entered verification code. Suitably, the device is configured to validate the entered verification code by comparing it with data stored in the memory and if the input verification code is not validated, an error message is generated. Suitably, the verification code is a PIN of the payment card selected. The validation may include carrying out an operation on or with the entered verification code and comparing the result of the operation with data in memory.

Suitably, the device comprises a wireless receiver and the device is configured to receive from a payment terminal one or more of the following data: information identifying the device and total transaction amount. Suitably, upon receipt of total transaction amount data from a payment terminal, the device displays data relating to the transaction. The receipt of this data may trigger the verification code request, i.e. an implicit request.

Suitably, the memory is configured to store payment details for a plurality of cards of a user and the device is configured to provide the option for the user to select from among the plurality of cards for payment. Suitably, the payment details are stored in an encrypted manner.

According to the present invention in a second aspect, there is provided a payment terminal, which payment terminal comprises:

a first communication channel for receiving an encrypted encryption key from another device;

a decryption module for decrypting the encrypted decryption key;

a memory for storing the encryption key;
a second communication channel for receiving payment details from the device, which payment details are encrypted using the encryption key; and
wherein the first communication channel is different to the second communication channel.

Suitably, the terminal further comprises a scanner for reading a machine readable code generated by a mobile communication device; and

the decryption module is configured to decrypt the machine readable code to derive therefrom data identifying the device. This can be the first communication channel.

Suitably, the device comprises a wireless receiver configured to receive encoded payment details and a verification code encrypted using the encryption key. Suitably, the wireless channel is via a Bluetooth channel. This wireless channel can therefore be the second communication channel.

Suitably, the apparatus further comprises a PIN request module for requesting a user's PIN. This may be an implicit request by sending to the device other information. Suitably, the terminal is configured to transfer to the device data relating to the payment. Suitably, the payment data comprises the total cost of the transaction.

Suitably, the payment is payment of cash, which may be to the user. The terminal may be an Automated Teller Machine (ATM).

According to the present invention in a third aspect, there is provided a payment system comprising a mobile communication device according to the first aspect of the invention and a payment terminal according to the second aspect of the invention.

According to the present invention in a fourth aspect, there is provided a method of communication between a mobile communication device and a payment terminal, the method comprising the steps of:
the mobile communication device using a first communication channel to transfer an encryption key from the mobile communication device to a separate terminal; and
   using a second communication channel to transfer payment details stored in the memory from the mobile communication device to the separate terminal, which payment details are encrypted using the encryption key; and
   wherein the first communication channel is different to the second communication channel.

According to the present invention in a fifth aspect, there is provided a computer program product carrying a computer program operable to perform the method of the fourth aspect of the present invention.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic diagram illustrating a payment system according to the present invention.

FIG. 2 is a schematic functional diagram illustrating a mobile communication device according to an embodiment of the present invention.

FIG. 3 is a schematic functional diagram illustrating a payment terminal according to an embodiment of the present invention.

FIG. 4 is a functional flow diagram illustrating a payment method according to an embodiment of the present invention.

FIGS. 5A-5M are illustrations of screenshots of a mobile telephone performing as a mobile communication device in the method shown in FIG. 4.

FIG. 6 is a relational diagram showing the options between screens of the device.

FIG. 7 is a schematic illustration of an alternative embodiment of the present invention in which the payment terminal is an ATM.

### DESCRIPTION OF THE PREFERRED EMBODIMENTS

The aspects and features of the present invention are described hereinafter with reference to flowchart illustrations of user interfaces, methods, and computer program products according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process or method such that the instructions that execute on the computer or other programmable apparatus provide steps for implementing the functions specified in the flowchart block or blocks.

Furthermore, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Embodiments of the present invention enable a mobile communication device to be used to complete a transaction using a credit or debit card.

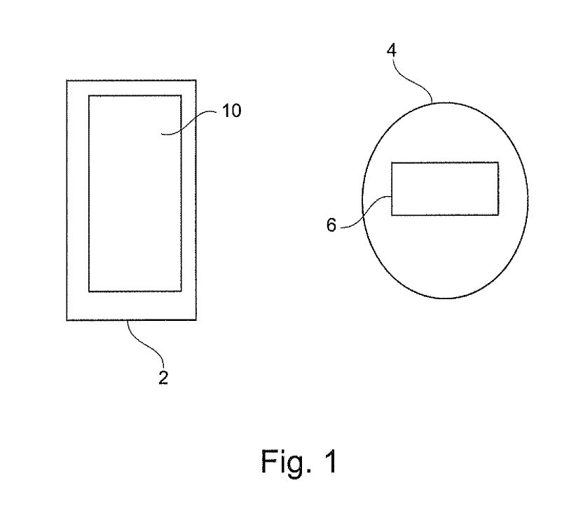

Referring to FIG. 1 of the accompanying drawings, there is shown a mobile communication device in the form of a mobile telephone 2 configured to operate according to the present invention and a payment terminal 4 configured to work with the mobile telephone 2. The payment terminal 4 includes an image scanner 6 for reading a visually represented machine-readable image.

The mobile telephone 2 is of a type commonly referred to as a “smartphone”. Normally this will mean the mobile telephone has an operating system by virtue of which applications (sometimes referred to as “apps”) can be added to and run on the mobile telephone. Examples of smartphones are Phones and Blackberrys, though the present invention has wider applicability and is generally applicable to handheld, portable communication devices including Personal Digital Assistants (PDAs).

The mobile telephone 2 includes a display panel 10 which in this case also acts as a touch-screen, user interface.

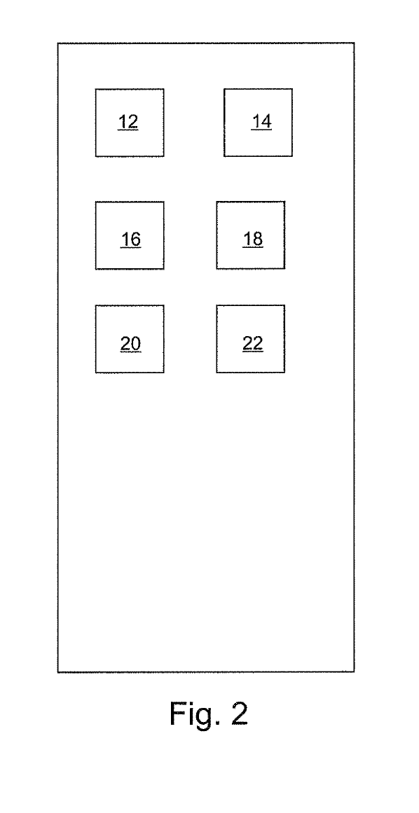

Referring to FIG. 2 of the accompanying drawings, the mobile telephone 2 comprises a memory 12, a display driver 14, a processor 16, an encryption/decryption module 18, a machine-readable image generation module 20 and a short-range transmitter/receiver module 22, which typically will be a Bluetooth transmitter/receiver.

The memory 12 will typically be a random access memory module.

The display driver 14 is configured to control the appearance of the screen of the display.

The processor 16 controls the operation of the mobile telephone 2.

The encryption/decryption module 18 is configured to encrypt and decrypt data using a symmetric algorithm.

The machine-readable image generation module 20 is configured to receive the output of the encryption module 18 and convert the encrypted information into a machine-readable image for the display screen 24. A suitable machine readable image is a QR code, a matrix code, sometimes referred to as a two-dimensional bar code, which is known for use with mobile telephones. In the case of using a QR code, the creation of the QR code image itself can form part of the encryption step. An alternative is a one-dimensional barcode.

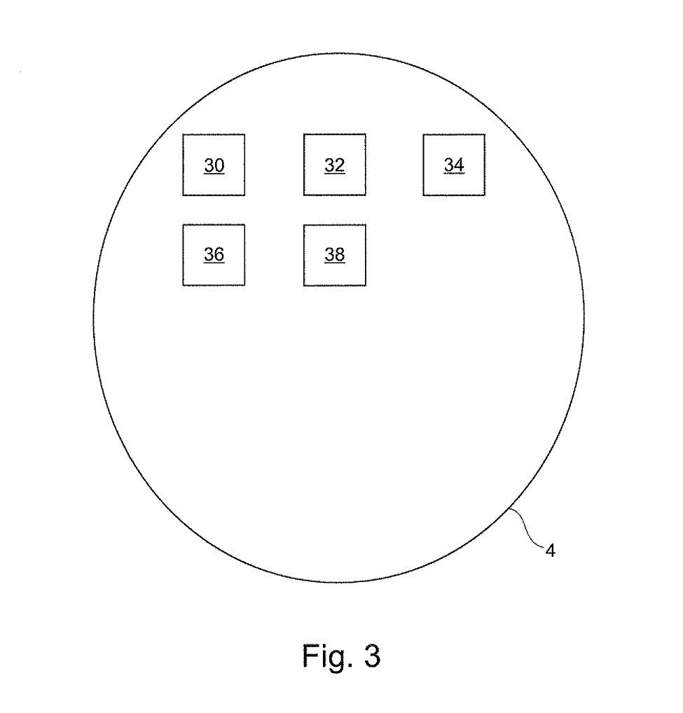

Referring to FIG. 3 of the accompanying drawings, the payment terminal 4 further comprises a processor 30, an image processor 32, a QR-image processing module 34, an encryption/decryption module 36, and a short-range transmitter/receiver module 38, which typically will be a Bluetooth transmitter/receiver.

The processor 30 is configured to control the operation of the terminal 4.

The image processor 32 is configured to read a QR code matrix generated by the machine-readable image generation module 20 which is displayed on the mobile telephone display panel 10.

The QR-image processing module 34 processes the QR image to generate the data therefrom.

The decryption module 34 is configured to decrypt the read QR image data.

A mobile telephone 2 is configured to operate as set out above by an application in the form of a computer program, which is typically downloaded to the mobile telephone upon request by a user.

A method of communication between the mobile communication device 2 and the payment terminal 4 for making a payment will now be described.

As an overview, a user loads their card details on to the mobile telephone 2, these card details are stored in encrypted form and the user selects a card to use for payment via an application on the mobile telephone 2. When adding a card, a user sets a PIN to be associated with that card. The PIN is operated on and the result of that operation is not stored on the telephone so it is used to encrypt and decrypt card's data. A user activates the application when wishing to make a payment and enters their password for the application. A card for payment is selected by a user. The mobile telephone 2 then passes an encryption key to a payment terminal using a machine readable image on the display 10, which is swiped over an image scanner 6 on the payment terminal 4. The mobile telephone 2 then looks up the encrypted card details in its memory 12. The encrypted information is transmitted to the payment terminal over a short range encrypted wireless connection, typically Bluetooth, when the user enters a correct PIN.

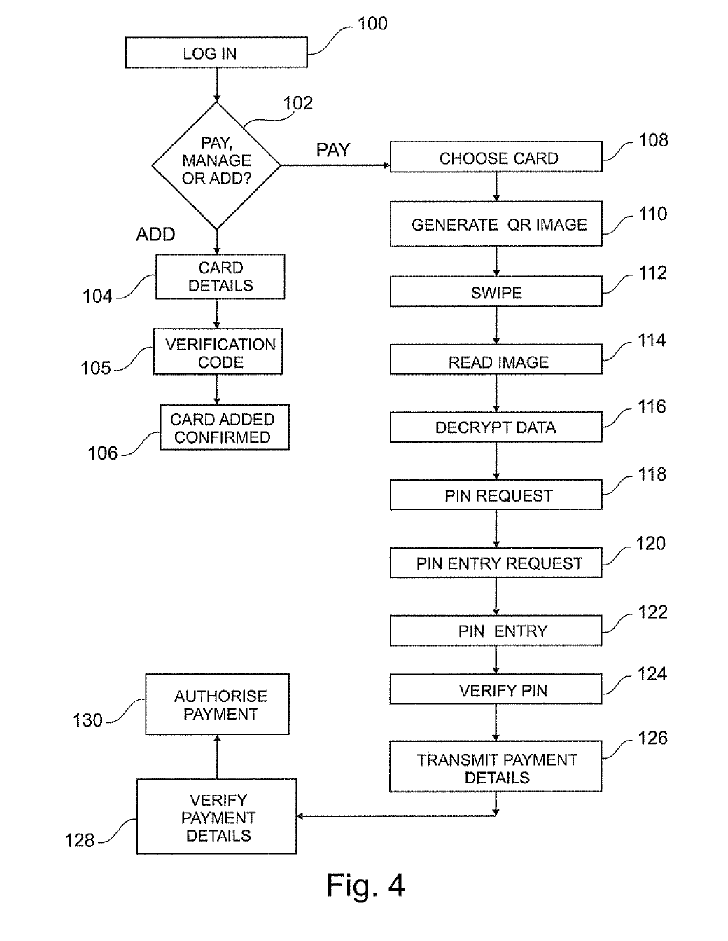

In more detail, with reference to FIGS. 4, 5 and 6 of the accompanying drawings:

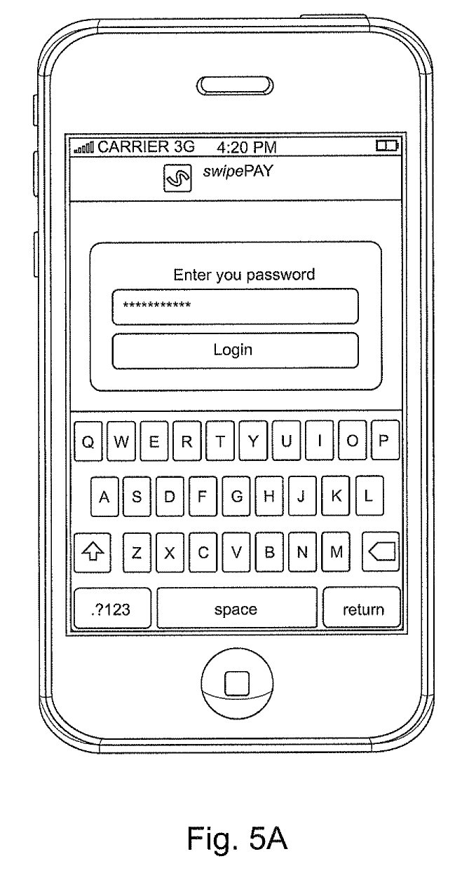

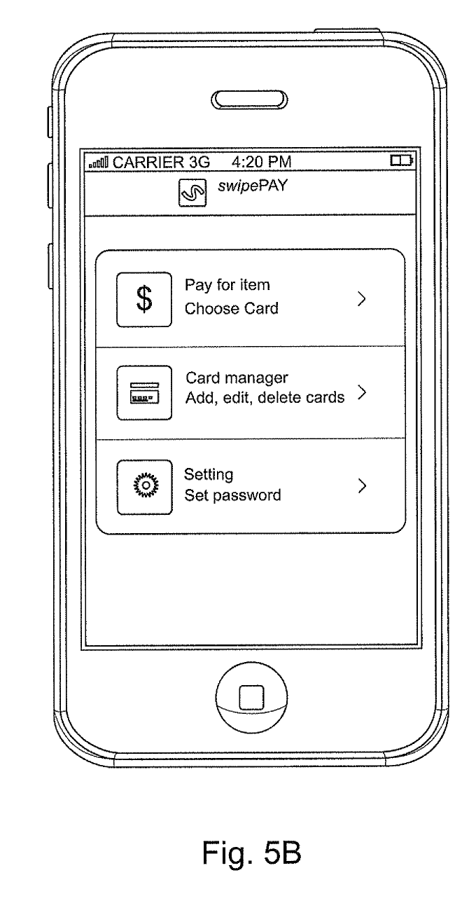

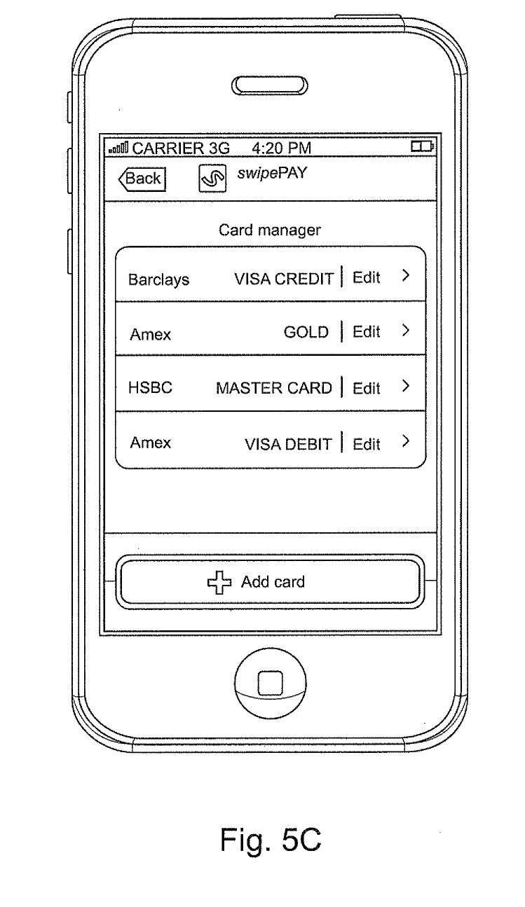

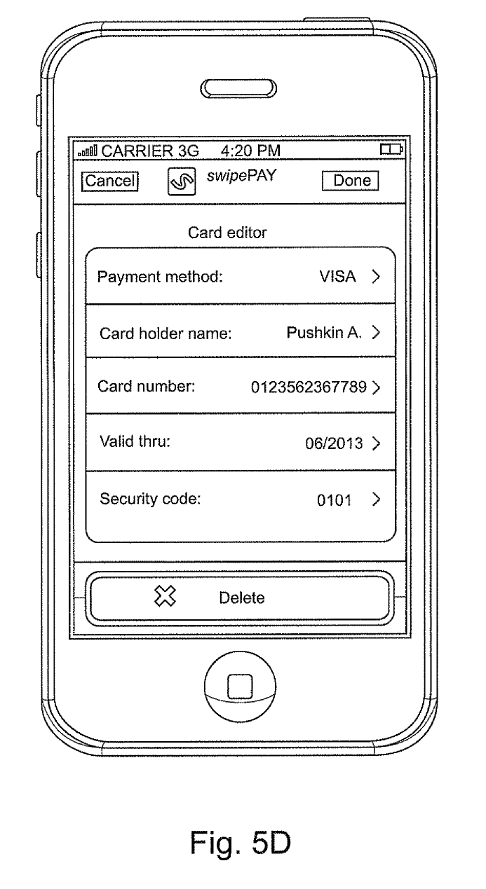

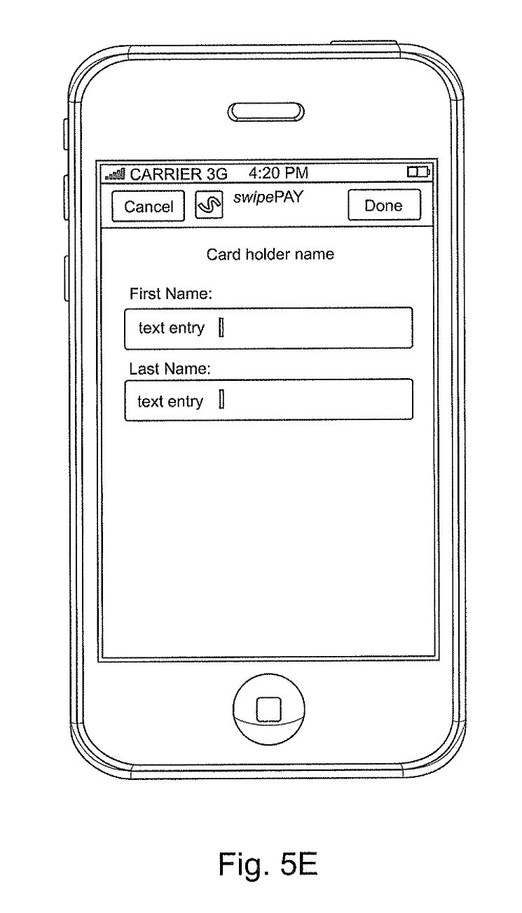

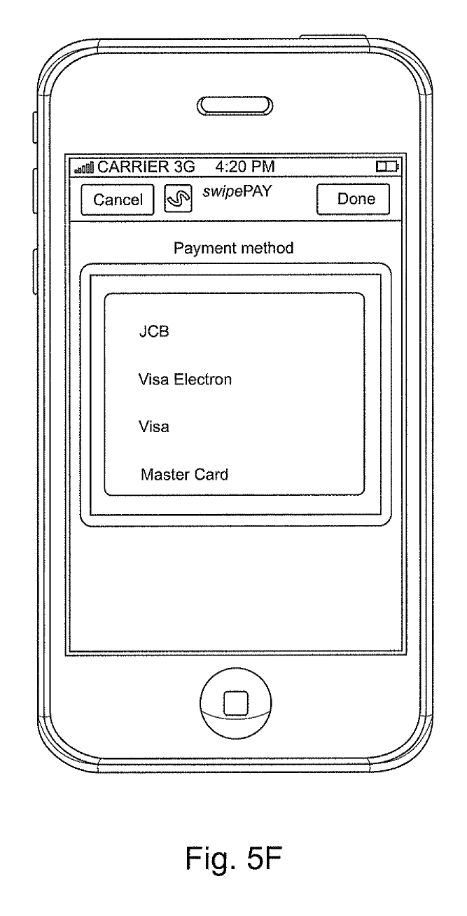

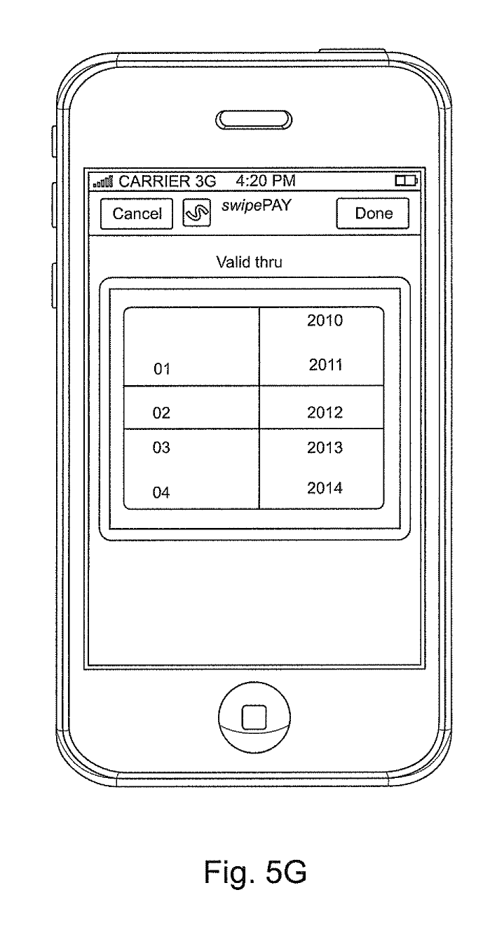

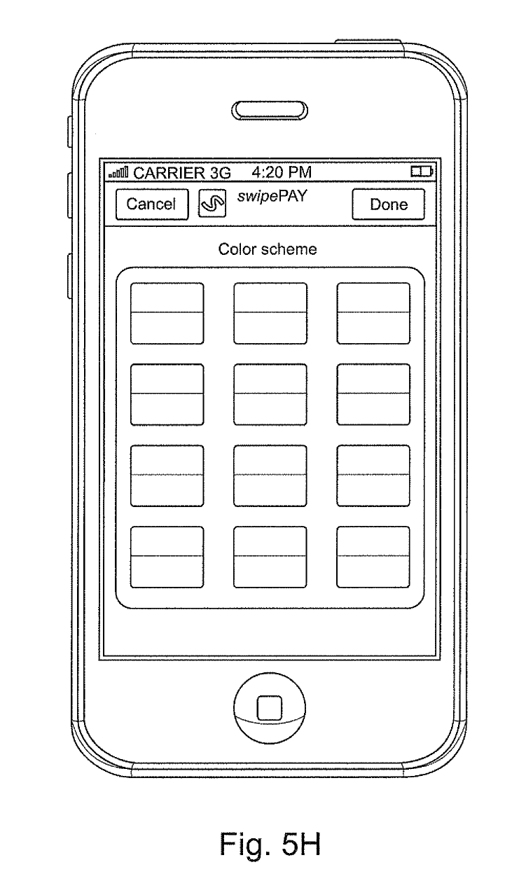

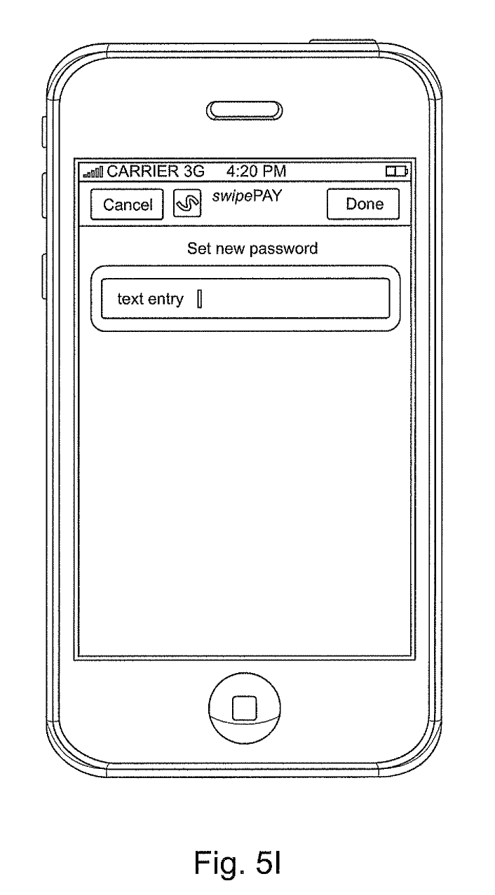

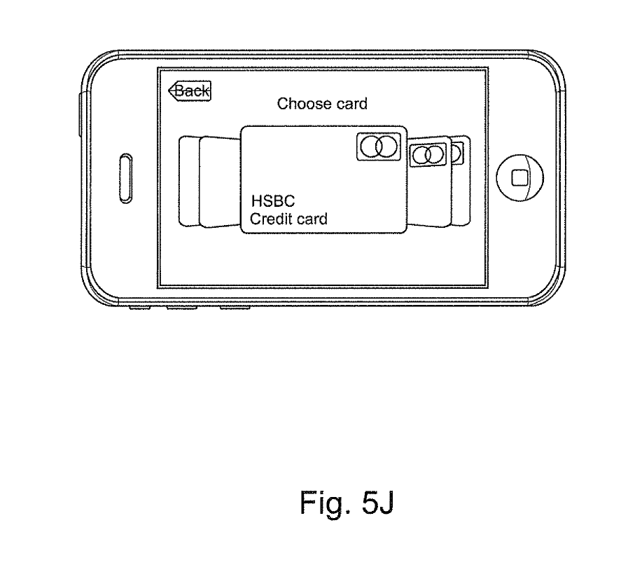

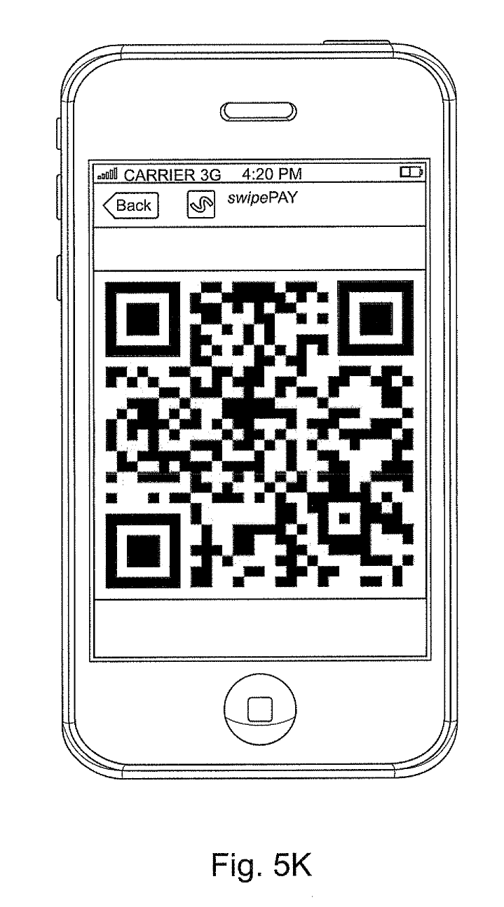

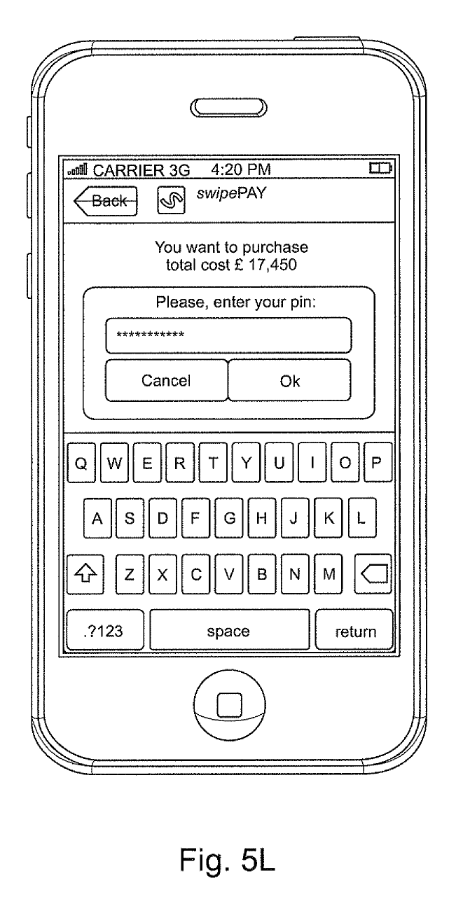

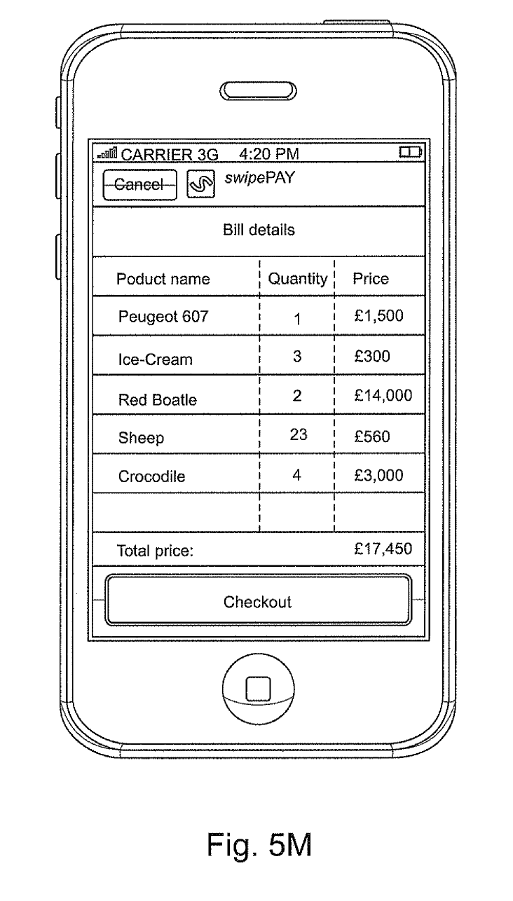

First, in step 100, as shown in the login screen of FIG. 5A, a user logs in to the application using a password preset by a user. The password is stored in an encrypted form in the mobile telephone memory 12. This is a necessary step whenever the application is activated and provides security to a user should their mobile telephone 2 be lost or stolen.

If a password is forgotten by a user the only option is to re-install the application on the telephone and re-enter the relevant card details.

In step 102, a user is presented with a screen on the mobile telephone display with three options, as shown in FIG. 5B, the home screen. Option one is to pay for an item. Option two is to manage card details, for instance to add or amend details of a card. Option three is to set (which includes change) a password.

If a user wishes to manage a card, the relevant selection is made and the user is transferred to the card manager screen shown in FIG. 5C. This lists the cards currently entered on to the telephone 2 and a user can select one of them to amend its details.

The options available from the card manager screen shown in 5C are summarized below:

| Events | Action of the app |
|---|---|
| “Back” button pushed | The App opens “Home” screen |
| The card pushed | The App requires to enter the card's pin (at |
| | the pop up). If the pin is entered correctly the |
| | App opens “Card details” screen with the |
| | data of the chosen card otherwise the App |
| | displays a notification on an incorrect pin* |
| The card pushed | The App deletes data of the chosen card; |
| The Pin has been entered | The App displays a notification on the card |
| incorrectly more than | removal; |
| 3 times | The App opens “Home” screen. |
| “Add card” button pushed | The App opens “Card details” screen |

If a user wishes to add a card, which may be a first or further card, then in step 104 the user enters the card details into fields presented on the mobile telephone display screen. Typically the card details to be entered are: cardholder name, card type (i.e. credit or debit card), payment method (e.g. VISA, MASTERCARD, DELTA, AMERICAN EXPRESS etc), bank name, card number, account number, expiry date, issue number (if applicable), security code and card colour (how a representative card is displayed on the screen). Each data set can be verified as of the correct type, e.g. account number 8 digits, CVC 3 digits. Some of these screens are illustrated in FIGS. 5D-5G, with the screens of FIGS. 5E-5G being accessible from the root page shown in FIG. 5D.

A user can select a colour scheme to be associated with the selected card from the screen shown in FIG. 5H.

The data within the card details screen is summarized below:

| | | Can be | Additional Screen |
|---|---|---|---|
| Card data | Restrictions | null? | where data can be set |
| Card type | Only the next card types | No | “Card type” screen |
| | are available: | | |
| | Credit card; | | |
| | Debit card. | | |
| Payment | Only the next payment | No | “Payment method” |
| method | methods are available: | | screen |
| | Diners Club | | |
| | International; | | |
| | JCB; | | |
| | Visa Electron; | | |
| | Visa; | | |
| | Master Card; | | |
| | Delta; | | |
| | American Express; | | |
| | Maestro; | | |
| | Switch. | | |
| Bank name | String (length: 20) | No | “Bank name” screen |
| Card holder | String (length: 30) | No | “Card holder name” |
| name | | | screen |
| Account | Digits (length: 15) | Yes | “Account No” screen |
| Number | | | |
| Card number | Digits (length: 20) | No | “Card No” screen |
| Valid from | Month/year | Yes | “Valid from” screen |
| Valid thru | Month/year | No | “Valid thru” screen |
| Issue number | String (length: 4) | Yes | “Issue No” screen |
| Secure code | Digits (length: 3) | No | “Secure code” screen |
| Card colour | 16 colours are available | No | “Card colour” screen |
| | (according to the design) | | |

The actions of the application from this screen are summarized below:

| Events | Action of the app |
|---|---|
| “Cancel” button | The App opens “Card” screen |
| pushed | Changes have not been saved. |
| The card's attributes | The App opens a pop up requiring to enter the |
| fulfilled | Pin (this Pin will be used to decrypt the card's |
| “Done” button pushed | data to edit the card or to make payments |
| | with this card). |
| | If the user has entered the pin and pushed “OK” |
| | button the App encrypts the card's data using |
| | hash with salt of the Pin and stored encrypted |
| | data. |
| | If the user has not entered the pin and pushed |
| | “OK” button the App does nothing (the pop up |
| | is not closed). |
| | If the user has pushed “Cancel” button the App |
| | closes the pop up and stays at “Card details” |
| | screen. |
| Required card's | The App displays a notification on null attributes. |
| attributes have not | |
| been fulfilled; | |
| “Done” button pushed | |
| card attribute pushed | The App opens the corresponding additional |
| | screen (see Error! Reference source not |
| | found.) |
| “Delete” button | The App deletes data of the chosen card; |
| pushed | The App opens “Card” screen. |

A user is then in step 105 required to enter a verification code in the screen of FIG. 5I (the personal identification number (PIN) for the card, typically). The verification code is combined with salt and a hash created, as is known. The encryption key used during transactions is randomly generated for each transaction. All card data stored on the telephone memory is retained in encrypted form. The user's verification code is not retained at all because it is one-way encrypted.

The options from the setting screen of FIG. 5I are:

| Events | Action of the app |
|---|---|
| “Cancel” button pushed | The App opens “Home” screen |
| | Nothing is stored. |
| New password has been | The App opens “Home” screen |
| entered | The password is set/changed |
| “Done” button pushed | |
| The password has not been | The App displays the corresponding |
| entered; | notification on no password input. |
| “Done” button pushed | |

Assuming all details are entered correctly, in step 106 a message is displayed on the mobile telephone display panel confirming that a card has been added.

If a user wishes to modify existing card details, a card is selected by touching the relevant card image. A user must first enter the verification code they have associated with that card. The entered verification code is encrypted through an algorithm making its size 128 bytes and this is this is used as a session key for encryption/decryption. If the verification code is correct, the user is then taken to the card editor screen shown in FIG. 5D. Here the payment method, card holder name, card number, valid thru (i.e. valid until) and security code (the 3-digit number on the back of a typical credit card, sometimes referred to as a Card Verification Code (CVC)) can all be amended. There is also the option to delete a card. The verification code will generally be a user's PIN.

The operations available from the screen of FIG. 5C are summarized below where application is abbreviated to “app”:

| Pressed button | Conditions | Action of the app |
|---|---|---|
| Pay for item | There is at least one card | The App opens “Pay” screen |
| | at the app | |
| | There is no cards at the | The App displays notification |
| | app | that there are no cards. |
| Card manager | Any | The App opens “Cards” |
| | | screen |
| Settings | Any | The App opens “Settings” |
| | | screen |

Alternatively, at step 102 a user may choose to use a card to pay for a transaction, in which case, an image illustrating the various cards that can be selected is displayed on the mobile telephone display, as shown in FIG. 5J. A user then, at step 108, selects one of these cards. If there is only one card loaded on the application, i.e. card details have only been input for one card, then this step may be omitted.

The options from this screen are summarized below:

| User's action | Action of the app |
|---|---|
| “Back” button pushed | The App opens “Home” screen |
| The card pushed | The App opens “QR code” screen |

Next, in step 110 a QR image is generated by the machine readable image generation module 20 and displayed on the mobile telephone display 10 by the display driver 14 as illustrated in FIG. 5K. The QR image contains the encrypted session key and an identifier of the device, typically the device MAC. Alternatively, this may be a one-dimensional bar code. If the Bluetooth function of the telephone 2 is off, additionally the Bluetooth functionality is activated automatically at this point.

The options from the QR-code screen of FIG. 5K are shown below:

| Events | Action of the app |
|---|---|
| “Back” button pushed | The App opens “Pay” screen |
| | Blue tooth is switched off |
| Swipe-pay terminal has set a session with | The App opens “Bill” screen |
| the iPhone via Bluetooth (see Error! | |
| Reference source not found.) | |

The user then, in step 112 swipes the machine readable image 40 across the scanner 9 of the payment terminal 4.

In step 114 the payment terminal 4 reads the machine readable image 40.

In step 116 the payment terminal 4 decodes the machine readable image 40 and the decryption module 36 decrypts the session key and MAC of the telephone 2.

In step 118 the payment terminal PIN requesting module 36 then makes a PIN request of the user in connection with the card for which payment details have been submitted. This is made by transmitting over the wireless connection the total bill data encrypted using the session key.

In step 120 a PIN entry screen, as shown in FIG. 5L, is shown on the display panel 10 inviting a user to enter a PIN. This screen is initiated upon receipt of the data referred to above from the payment terminal 4. The PIN in this example is used as the verification code for the transaction.

In step 122 the user enters a PIN and, upon making a confirmation that the PIN is correct, the PIN is transmitted from the mobile telephone 2 to the payment terminal 4 using the mobile telephone Bluetooth transmitter 22 and terminal Bluetooth receiver 38 with additional payment information. The transaction total is diplayed for the user on the PIN entry screen.

At the PIN screen, the following options are available:

| Events | Action of the app |
|---|---|
| “Back” button pushed | The App opens “Bill” screen |
| The correct pin code of | The App encrypts the next card's data with the |
| the card has been | encryption key and sends it (data) to Swipe |
| entered and “OK” | pay terminal via Blue Tooth: |
| button* pushed | Card number; |
| | Card type; |
| | Payment method; |
| | Card holder name; |
| | Account number; |
| | Valid from; |
| | Valid thru; |
| | Issue number; |
| | Secure code. |
| | Blue tooth is switched off; |
| | The App displays a notification on the |
| | transaction |
| “Cancel” button pushed | Blue tooth is switched off; |
| | The App opens “Home” screen. |
| An incorrect pin code | The App displays a notification on entering an |
| of the card has been | incorrect pin code |
| entered and “OK” | |
| button* has been pushed | |
| An incorrect pin code of | The App deletes data of the chosen card; |
| the card has been entered | The App displays a notification on the card |
| more than 3 times and | removal; |
| “OK” button* has been | Blue tooth is switched off; |
| pushed | The App opens “Home” screen. |

Accordingly, if the PIN is correct in steps 122 and 124 (which the mobile telephone 2 can verify by creating a hash and comparing with the stored hash), in step 126 the user is presented with a final checkout screen 5M and the telephone 2 transmits wirelessly to the terminal 4 the following information payment information:
Payment method;
Card type;
Card holder name;
Account number;
Card number;
Valid thru;
PIN
Issue No (if applicable); and
Security code.

In step 128 the terminal decrypts the card data payment information using the session key and checks it via a connection to the banking system. If something is wrong with the card data the terminal gets the corresponding notification. In this case it is necessary to repeat all steps once again with some other card (the terminal does not send any notifications to the telephone).

If the payment details are verified as correct in step 128, the payment terminal 4 communicates the authorisation of the funds transfer in the usual way in step 130. If the payment details are not verified then the payment will be declined.

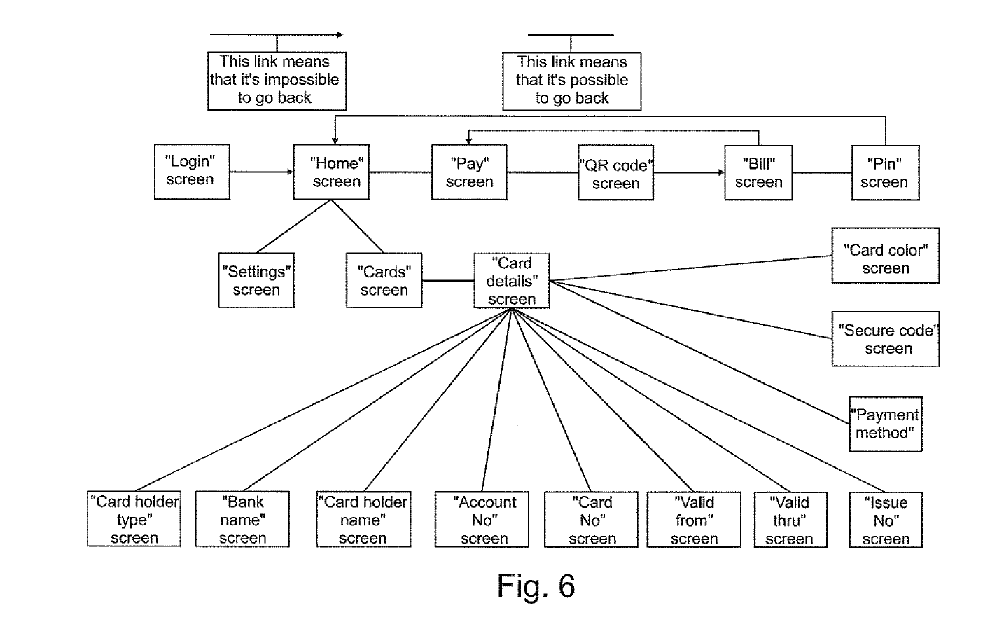

FIG. 6 is a relational diagram showing the options for the various screens displayed to a user.

Therefore, two separate communication channels are used to communicate the necessary data from the mobile telephone 2 to the payment terminal 4. That is, the encryption key and device MAC are conveyed via a machine readable code on the mobile telephone display 10 read by scanner 9 (the first channel, a visible channel) and a wireless transmission is used for other data (the second channel, a wireless channel). Using Bluetooth the wireless transmission is encrypted. If another wireless option is employed, the data should be encrypted.

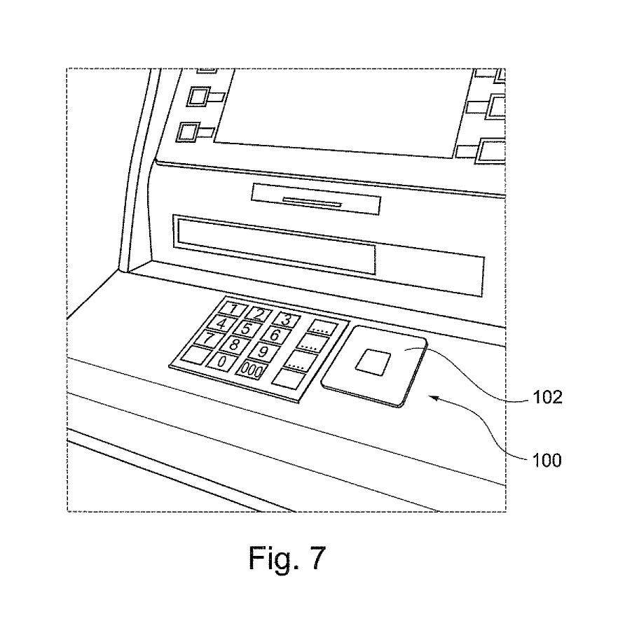

In a further embodiment of the present invention, the application on mobile communication device can be used to withdraw money from an automated teller machine (“ATM”). This is illustrated in FIG. 7 of the accompanying drawings showing an ATM 100 having an image scanner 102 for reading the QR-code. In this case, instead of the list of purchased items and the total being transmitted from the terminal (which in this case will be the ATM), the ATM transmits the amount to be withdrawn only. In this case the payment is to the user.

In an alternative embodiment of the present invention, the payment terminal described above does not itself undertake the payment authorisation but is connected to an existing point of sale card payment device to do so. The payment terminal 4 is connected via a USB cable to a known Point of Sale (POS) apparatus which processes customers' credit and debit card payments using known “chip-and-pin” technology. The present invention is equally applicable to any payment that can be accepted at a PoS terminal.

It should be noted that embodiments of the present invention provide a more secure and convenient communication method and system for financial transactions. A user need not carry about cards that can be taken and misused. An extra layer of security is added in that to even commence use of a user's card, a user name and password combination is required. This is in addition to any additional password security on a user's mobile telephone.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-29. (canceled)

30. A mobile communication device, the device comprising:
a memory;
an encryption module for encrypting data using an encryption key;
a first communication channel configured to transfer the encryption key from the mobile communication device to a separate terminal; and
a second communication channel for transferring payment details stored in the memory from the mobile communication device to the separate terminal, which payment details are encrypted using the encryption key; and
wherein the first communication channel is different to the second communication channel.

31. The mobile communication device of claim 29, wherein the mobile communication device further comprises:
a display screen; and
a machine readable image generator, configured to generate an image on the display screen, the image comprising an encrypted version of the encryption key.

31. The mobile communication device of claim 29, wherein the device is configured to transfer using the first communication channel data identifying the device.

32. The mobile communication device of claim 29, wherein the image further comprises data identifying the device.

33. The mobile communication device of claim 32, wherein the identifying data is the device's Media Access Control (MAC) address.

34. The mobile communication device of claim 29, wherein the device comprises a wireless transmitter configured to transmit encoded payment details encrypted using the encryption key.

35. The mobile communication device of claim 34, wherein the wireless transmission is via a Bluetooth channel.

36. The mobile communication device of claim 29, wherein the payment details are selected from any combination of any of: card type, payment method, valid from, account number, issue number, expiry date, cardholder name, card number and secure code.

37. The mobile communication device of claim 29, wherein the device is configured whereby upon receipt of a verification code request from a payment terminal, a user is requested to input a verification code, which verification code is transmitted to the payment terminal.

38. The mobile communication device of claim 37, wherein a one-way operation, such as a hash or add salt and hash operation is carried out on the entered verification code.

39. The mobile communication device of claim 37, wherein the device is configured to validate the entered verification code by comparing it with data stored in the memory and if the input verification code is not validated, an error message is generated.

40. The mobile communication device of claim 37, wherein the verification code is a PIN of the payment card selected.

41. The mobile communication device of claim 39, wherein the validation includes carrying out an operation on or with the entered verification code and comparing the result of the operation with data in memory.

42. The mobile communication device of claim 29, wherein the device comprises a wireless receiver and the device is configured to receive from a payment terminal one or more of the following data: information identifying the device and total transaction amount.

43. The mobile communication device of claim 29, wherein the memory is configured to store payment details for a plurality of cards of a user and the device is configured to provide the option for the user to select from among the plurality of cards for payment.

44. The mobile communication device of claim 43, wherein the payment details are stored in an encrypted manner.

45. A payment terminal, which payment terminal comprises:
a first communication channel for receiving an encrypted encryption key from another device;
a decryption module for decrypting the encrypted decryption key;
a memory for storing the encryption key;
a second communication channel for receiving payment details from the device, which payment details are encrypted using the encryption key; and
wherein the first communication channel is different to the second communication channel.

46. The payment terminal of claim 45, wherein, the terminal further comprises a scanner for reading a machine readable code generated by a mobile communication device; and
the decryption module is configured to decrypt the machine readable code to derive therefrom data identifying the device.

47. The payment terminal of claim 45, wherein the device comprises a wireless receiver configured to receive encoded payment details and a verification code encrypted using the encryption key.

48. The payment terminal of claim 47, wherein the wireless channel is via a Bluetooth channel.

49. The payment terminal of 45, wherein the apparatus further comprises a PIN request module for requesting a user's PIN.

50. A payment system comprising a mobile communication device, the device comprising:
a memory;
an encryption module for encrypting data using an encryption key;
a first communication channel configured to transfer the encryption key from the mobile communication device to a separate terminal; and
a second communication channel for transferring payment details stored in the memory from the mobile communication device to the separate terminal, which payment details are encrypted using the encryption key; and
wherein the first communication channel is different to the second communication channel, and
a payment terminal which payment terminal comprises:
a first communication channel for receiving an encrypted encryption key from another device;
a decryption module for decrypting the encrypted decryption key;
a memory for storing the encryption key;
a second communication channel for receiving payment details from the device, which payment details are encrypted using the encryption key; and
wherein the first communication channel is different to the second communication channel.

51. A method of communication between a mobile communication device and a payment terminal, the method comprising the steps of:
the mobile communication device using a first communication channel to transfer an encryption key from the mobile communication device to a separate terminal; and
using a second communication channel to transfer payment details stored in the memory from the mobile communication device to the separate terminal, which payment details are encrypted using the encryption key; and
wherein the first communication channel is different to the second communication channel.

52. A computer program product carrying a computer program operable to perform the method of claim 51.
